(19) United States
(12) Patent Application Publication
(10) Pub. No.: US 2012/0001919 A1
(43) Pub. Date: Jan. 5, 2012

(54) Social Graph Based Recommender

(76) Inventor: Erik Lumer, Milan (IT)

(21) Appl. No.: 13/125,298

(22) PCT Filed: Oct. 20, 2009
(86) PCT No.: PCT/US09/61311

§ 371 Date: Sep. 19, 2011

Related U.S. Application Data
(60) Provisional application No. 61/106,625, filed on Oct. 20, 2008.

(51) Int. Cl. G06T 11/20

(52) U.S. Cl. 345/440

(57) ABSTRACT

Personalized sorted lists of data items for users within an online social network can be generated. Users within the social network are profiled based on their interests. Concepts are segmented in the ontological database into clusters of concepts that are shared by several user profiles. A social graph is defined in which nodes represent the users within the social network and edges represent the explicit connections between the users. A neighborhood graph for each concept cluster is defined. Multilayered social affinity graphs are defined. Data items acted upon by users within the social network in a given time interval are identified. Users within the social network that have acted upon the identified data items are determined. One or more layers of the social affinity graphs are selected for each identified item. Initial endorsement values in the nodes are injecting for each identified item. The endorsement values are propagated across the selected layers of the social affinity graphs for each identified item until some stopping criteria is met. A sorted list of items acted upon by other users is generated for each user within the social network.

### BACKGROUND OF THE INVENTION

1. Field of the Invention

The present invention generally relates to social networks. More specifically, the present invention relates to a social graph based recommender.

2. Description of the Related Art

The proliferation of Web-delivered content services with a social component, where users generate, share, rate and comment information items (e.g. site bookmarks, book recommendations, message posts), along with the unprecedented volume of items published daily within such services, leads to a common situation of information overload. To help users find relevant content, two popular approaches have been adopted by many online social sharing services. First, filters can be provided to sort content items according to their overall popularity, as measured for example by the number of times each item is viewed or favorably rated. Such aggregated usage-based filters are commonplace in a number of Internet social content aggregators, including at user-generated video site YouTube and news aggregator site Digg. Second, social networking functionality can be provided whereby users can link with others explicitly, gaining access to the items produced by these contacts. For example, in the site operated by Facebook, members can invite other members to connect as friends, thus making their individual profiles and postings mutually visible.

Both of the aforementioned approaches suffer from limitations. Popular voting tends to rapidly lock into the spotlight a few items, which get increasingly reinforced in their most popular status by virtue of being more visible to visitors of the content site. Moreover, such items reflect mainstream preferences, with no discrimination for individual interests or tastes. The filtering of content items on the basis of one's social connections, on the other hand, has the drawback of excluding the vast majority of potentially relevant items which are not directly shared by an individual's friends. Moreover, linking to friends is an explicit, time-consuming task for users that is unlikely in general to correctly match the diversity and mutable nature of individual interests.

Recommender systems have also been used in order to provide personalized suggestions in content-rich Web environments. These systems often use statistical algorithms to perform what is known in the literature as automated collaborative filtering (ACF). Basically, the algorithms compute for each user a neighborhood consisting of those users who most closely share similar tastes within given content domains. As a result, the recommender systems are able to provide personalized recommendations, predicting how much an item is likely to appeal to a user based on how its neighbors have acted upon the item. Users can act upon (or equivalently evaluate) an item in many different ways. For example, acting upon an item may include submitting an explicit numerical rating of the item, commenting on the item, and reading or viewing it. The main advantage of ACF over traditional content-based filtering is that it can generate recommendations for any kind of content (e.g. text, music, movies, etc) and integrate hard to represent concepts such as taste and quality. Recommender systems based on ACF have been used for example to provide personalized suggestions for book purchases or movie viewing in various e-commerce sites, including at Netflix and Amazon (See US Publication No. 7113917 incorporated by reference herein). Only recently, similar techniques have been introduced to provide content recommendations in online communities, for example in news and music related communities (See, e.g. US Publication No. 2007/0203790 to Torrens, incorporated by reference herein). A recommender system, based on ACF or hybrid collaborative and content-based filtering methods, applied to multiple input sources has also been proposed recently to generate predictions concerning data items spanning multiple domains (e.g. message posts, RSS feeds, blogs, images, other users within a community, etc). (See US Publication No 2008/0077574 incorporated by reference herein).

Such recommender systems, however, suffer from several drawbacks that limit their applicability to filter the open-ended, multi-domain and multi-topic information items that are created and shared within large online communities. One shortcoming of collaborative filtering in such context is the sparsity problem: The number of item evaluations obtained from users is usually very small compared to the number of evaluations that must be predicted. The computation becomes harder in the case of extremely sparse user-item matrices, as is the case for the evaluations of the many millions of messages shared daily within large social media. Another related shortcoming is that the dissemination of information through recommendations within a large community can be very slow, as it depends on positive items evaluations from users within the similarity neighborhood of the recipient of such recommendations. This is particularly deleterious when the relevance of an item is short-lived, as is the case for example with news entries or contributions to collective conversations. A third shortcoming resides in the global comparison typically done between users to select ACF neighbors, in such a way that partial, but useful similarities may be missed. For example, two users may have similar tastes in music, but contrasting ones in sports. Finally, the algorithms used in such recommender systems fail to exploit the implicit trust as reliable sources of information granted to contacts within online social networks.

Tying all these factors together, it is apparent that there is a considerable need for new methods to quickly and selectively propagate information items shared through online social communities, so that users can effectively extract, filter and discover information of interest to them.

### SUMMARY

Innovative techniques based on the constrained propagation of Web item endorsement information across social graph structures are used to provide personalized suggestions to users profiled within one or more online social networks.

A method for propagating item endorsements across the social graph (where nodes represent members and edges declared connections between them) within a given online social network, according to one aspect of the invention, includes monitoring activities of members to track the items that they act upon. For each item acted upon, an initial endorsement value is injected into the node of the social graph associated with the endorsing member. A fraction a of this value sticks to the node, while the remainder (1−α) flows through the in-links of the node. Propagation continues down the graph for each item acted upon until a stopping criterion is met. The final intensity of the item endorsement value accumulated at a target node plays the role of the item node-specific relevance rank. The items can then be sorted by their rank to provide personalized recommendations, to filter out items in subscriptions below a threshold score or to personalize search engine results presented to members. It should be apparent to those expert in the art that the above-described graph propagation algorithm is only one of several variants that can be devised within the scope of the present invention to optimize the computational efficiency and scalability of the method. Experts in the art will recognize that analogous algorithms have been analyzed in the field of personalized Web search engines, where diffusion across the Web hyperlink structure is used to compute the authority of Web pages.

A method for propagating item endorsements within a given online social network, according to another aspect of the invention, includes profiling members based on the items they act upon or on their topical interests as deduced from the semantic analysis of the textual information attached to items that they acted upon. The method combines into a single social affinity graph, the explicit friends graph with a neighborhood graph, constructed by connecting each member to the top-k other members that share more strongly similar tastes or interests. The monitored endorsement information can then be propagated across the affinity graph using the algorithms described above to produce personalized item rankings.

The method in the present invention also takes into account that a person is inherently interested in multiple topics, with idiosyncratic preferences. To support this aspect, the method may also be applied to multilayered affinity graphs, obtained by dividing user profiles in clusters of cohesive interests and based on this constructing several layers of affinity graphs where similarities with other people are established considering only a subset of the user profiles. Depending on the topic specificity of an information item acted upon, only one or a few layers can then be involved in the propagation of the item endorsements.

In a preferred embodiment of the present invention, a computer implemented system to propagate items endorsements through multi-layered social affinity graphs, according to the above-described method, profiles users' interests and social connections across multiple social networks while collecting through a Web portal, a browser plug-in or any other suitable client application, user feedback (e.g. rating, comments, annotations) for any addressable Web object, so as to provide personalized recommendations for an arbitrary range of information items. The preferred embodiment of the present invention, therefore, provides a horizontal Internet social discovery and information dissemination system.

Other possible embodiments and applications of the invention will become readily apparent upon review of the following descriptions.

### BRIEF DESCRIPTION OF THE FIGURES

FIG. 1 is an illustration of social graph based recommender system of the present innovation.

FIG. 2 is a flowchart illustrating an exemplary method of generating with a computing system personalized sorted lists of data items for users within an online social network.

FIG. 3 is a flowchart illustrating an exemplary method of generating with a computing system personalized sorted lists of data items for users within an online social network.

FIG. 4 is a flowchart illustrating an exemplary method of generating with a computing system personalized sorted lists of data items for users within an online social network.

FIG. 5 illustrates an exemplary computing system that may be used to implement an embodiment of the present technology.

### DETAILED DESCRIPTION

In what follows, the present invention will be described in reference to embodiments that generate personalized rankings for information items acted upon by profiled users of the World Wide Web. More specifically, the embodiments will be described in reference to generating personalized ranked lists of Web items for recommendation purpose, using a social graph based constrained propagation method. However, embodiments of the invention are not limited to any particular environment, application or specific implementation. For example the embodiments described below are in reference to uniquely identified Web items (e.g. activity feed entries in online social networks, site links, blog posts, Web videos, etc) but the invention can be advantageously applied to provide suggestions for any type of information item acted upon by users profiled within a social graph (e.g. email messages, applications for mobile phones, reference to a physical place, etc). Therefore, the description of the embodiments that follows is for purposes of illustration and not limitation.

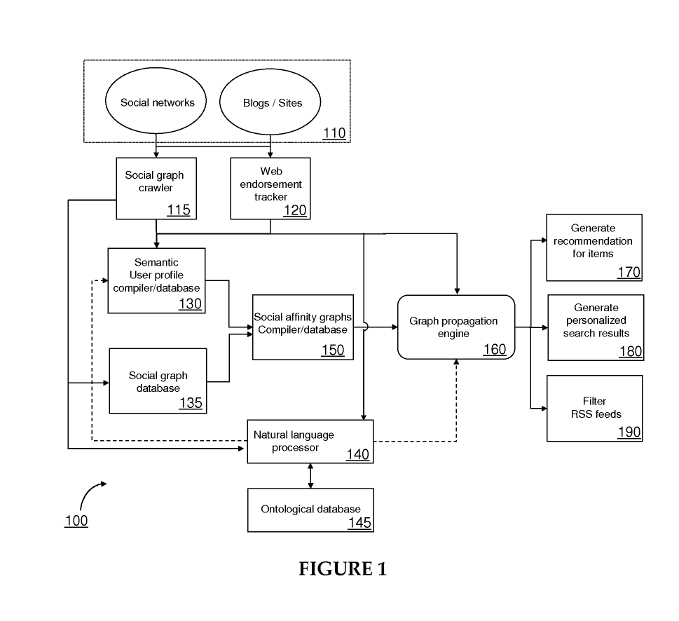

FIG. 1 illustrates a preferred embodiment of the present invention. A social graph based recommender system 100 includes a graph crawler 115 that scans different online sources 110, such as social media, Blogs and personal Web sites, to collect information about the public connections between people. This information can be expressed on personal Blogs and Web pages for example by XFN and FOAF markup and collected through standard Web crawling techniques well know in the art; the crawler can also extract information from online social media by mining the data that they expose with specific API schemes. On most social media services, users are permitted to publish new items or provide explicit evaluations for Web items published by others, mainly by rating, commenting or designating as favorites such items. The graph crawler 115 also monitors and aggregates such user contributions.

The recommender system 100 also comprises a cross-site Web endorsement tracker 120, allowing users of the system to provide explicit evaluations, in the form of ratings and comments, for any uniquely identifiable Web item that they access through a browser. By monitoring Web activity, the Web endorsement tracker 120 can also capture implicit evaluations of Web items acted upon by users, for instance by bookmarking a Web page, viewing on online video or through any other user interaction which can be interpreted as a measure of user's interest for an item. It will be apparent to those skilled in the art that the Web endorsement tracker 120 can be implemented in several different ways, the details of which are not material to the present invention.

A semantic user profile compiler and database 130 elaborates and stores user interest profiles utilizing the information about user contributions (items evaluations and posts) collected through the social graph crawler 115 and the Web endorsement tracker 120. The information about connections between people further captured by the social graph crawler 115 is stored in a social graph database 135.

In the preferred embodiment, the textual data associated with the collected items that a user acted upon are fed through a natural language processor 140, coupled to a general ontological database 145 such as WordNet, which maps relevant words comprised in the textual data onto concepts in the ontology to identify the concepts representing a user's interests. The captured knowledge about a user's interest is stored in the profile database 130 as a vector uᵢ=(u_{i,1}, u_{i,2}, . . . , u_{i,N}) where the weight u_{i,j} measures the intensity of the interest of user uᵢ for concept cⱼ in the ontology, and N is the total number of concepts in the ontology. The ontology-based representation of user profiles adopted in the preferred embodiment of the invention is richer and less ambiguous than a keyword-based or item-based model. When the number of data items is very high, as this the case with arbitrary Web items, this representation also mitigates the scarcity problem present in traditional recommender systems that operate directly on the raw user-item matrix.

Utilizing the user-concept matrix composed of all the semantic profile vectors stored in the semantic user profile database 130, a social affinity graphs compiler and database 150 segments the concepts in the ontological database 145 into groups of concepts that are shared by several users. Standard clustering techniques well known in the art, such as the hierarchical clustering or the K-means clustering algorithms, can be utilized to this end. Once the concept clusters are computed, the user profiles can be broken into coherent subsets of interests obtained by projecting the profile vectors in turn onto each cluster. The similarity in interests between users can then be calculated for each of the above-derived subset of interests using standard similarity measures well know in the art (e.g Pearson measure) to define for each user and concept cluster the top-k most similar neighbors. Finally, a weighted directed social affinity graph is obtained for each concept cluster by combining the social graph structure with a neighborhood graph obtained by connecting each node to its cluster-specific neighbors. Quantitatively the weight of an edge joining two nodes in the affinity graph can be a simple mathematical relationship of their interest similarity and social degree of separation. For example, one implementation may compute the weight of an edge joining two nodes as the product of their cluster-specific similarity and the inverse of their degree of separation in the social graph. The resulting multilayered affinity graphs are stored in a social affinity graphs database 150.

A graph propagation engine 160 provides a novel method to efficiently propagate, on-the-fly, item endorsements through the multilayered social affinity graphs. Using the natural language processor 140, each Web item dₖ acted upon by a profiled user first gets represented as a vector dₖ=(d_{i,1}, u_{i,2}, . . . , d_{i,N}) of concept weights in the same vector space as user interest profiles. One or more layers of the social affinity graphs are hence selected according to the concept clusters that present the strongest similarity with dₖ. For items that cannot be readily mapped onto concepts, a default affinity graph layer constructed on the user-item matrix rather than the user-concept matrix can be selected instead. For each selected layer, the endorsement of item dₖ by a user uᵢ is propagated across the layer's social affinity graph as follows. An endorsement value reflecting the evaluation of dₖ by user uᵢ is injected into the node i associated with uᵢ in the graph. A fraction α of this value sticks to the node, while the remainder (1−α) is distributed to the nodes pointing to i proportionally to the weight of their connections to i. Propagation continues down the graph for each item acted upon until a stopping criterion is met. Finally, the intensity of the resulting item relevance value accumulated at a given node is summed across all selected layers and added to the amount of endorsement previously accumulated for the item (possibly reduced by a function of elapsed time) to produce a personalized relevance ranking of the item. While the above-described multilayer propagation algorithm (MPA) represents a conceptual way of calculating personalized item relevance ranks, more efficient versions of MPA can be implemented. The details of such implementations, however, are not material to the underlying principles of the present invention.

The outputs generated by the graph propagation engine 160, i.e. personalized lists of ranked items at nodes reached by the propagation process, can be used in a number of way to improve information access for users, including: 1) presenting users with personalized feeds of recommended items 170, where the top-k Web items with highest relevance ranking in a given period, not previously suggested to a user, are selected to update this user's recommendation feed; 2) adjusting according to the personalized item ranks search engine results presented to a user in response to a query 180; 3) sorting and filtering the items in friends activity feeds and other RSS feeds subscribed by a user 190.

It will be obvious to those skilled in the art that countless variations on the above-described embodiment can be implemented without departing from the underlying principles of the invention. Thus, social affinity graphs reduced to a single layer or to the social friends graph, or using a neighborhood graph based on user-item rather than user-concept similarities are all to be viewed as special cases of the above-described preferred embodiment. Additional processing or modules could also be added to alternative embodiments of the present invention. For example, in an alternative preferred embodiment, the outputs of the graph propagation engine 160 are further filtered by a context processing module that operates using knowledge reasoning (KR) methods well known in the art to retain only the subset of propagated information items bearing direct relationship to a user's current context (e.g. a topic, a set of users or a task at hand, a physical location, etc). Furthermore, it will be apparent to those skilled in the art that the modules of the present invention, including those illustrated in FIG. 1. can be implemented any one of many know programming languages suitable for creating applications that can run on large scale computing systems, comprised of networked servers and a variety of end-user computing systems. The details of the software routines required to realize the functionally described above in such modules may also be implemented in any number of ways. These software details along with the specific programming languages and hardware configurations employed are not material to the present invention.

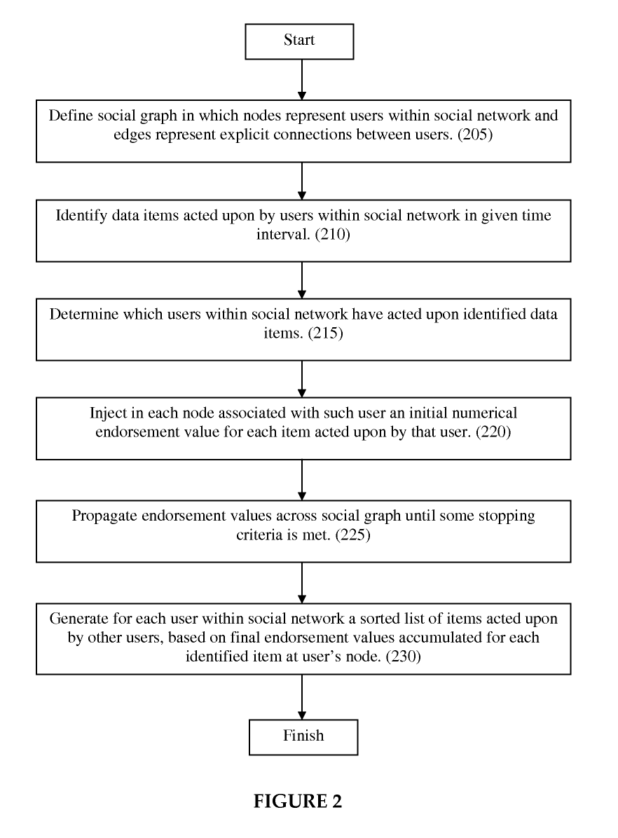

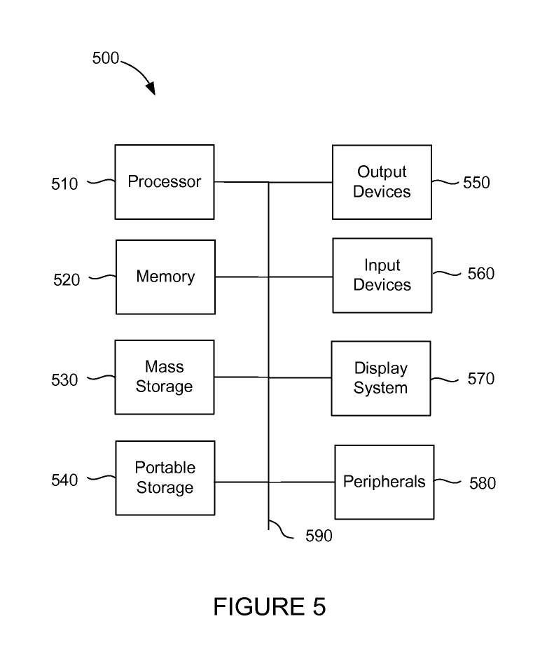

FIG. 2 is a flowchart illustrating an exemplary method 200 of generating with a computing system personalized sorted lists of data items for users within an online social network. The steps of the method 200 may be performed in varying orders. Additionally, steps may be added or subtracted from the method 200 and still fall within the scope of the present technology. Various computing systems can perform the method 200, as described in connection with FIG. 5.

In step 205, a social graph is defined. Nodes can represent the users within the social network and edges the explicit connections between them. In step 210, data items are identified that act upon by users within the social network in a given time interval. In step 215, the users within the social network that have acted upon the identified data items are identified. In step 220, each node associated with such user is injected with an initial numerical endorsement value for each item acted upon by the user. In step 225, the endorsement values are propagated across the social graph until some stopping criteria is met. In step 230, a sorted list of items acted upon by other users is generated for each user within the social network. Each sorted list is based on the final endorsement values accumulated for each identified item at the user's node.

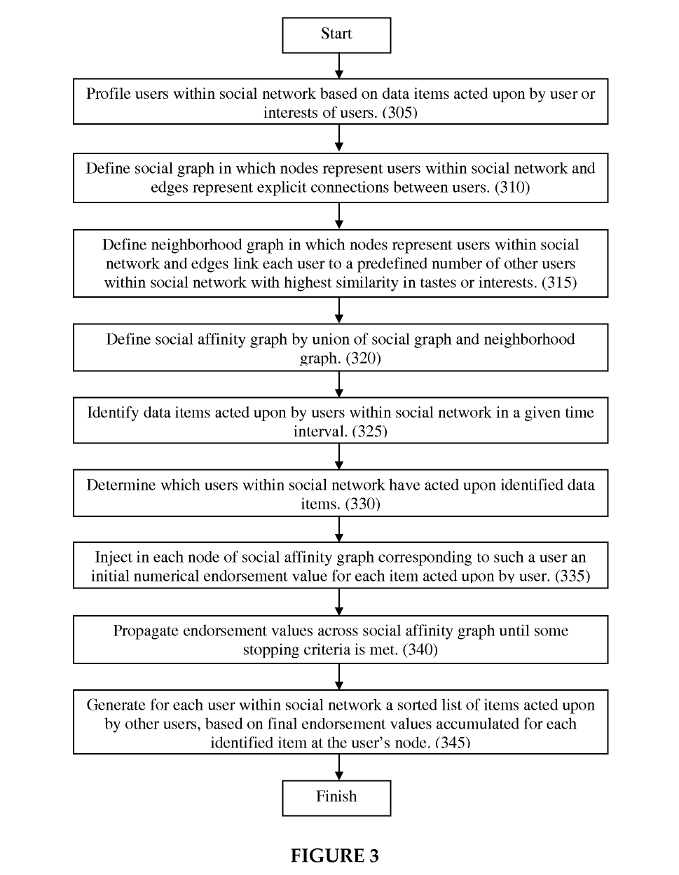

FIG. 3 is a flowchart illustrating an exemplary method 300 of generating with a computing system personalized sorted lists of data items for users within an online social network. The steps of the method 300 may be performed in varying orders. Additionally, steps may be added or subtracted from the method 300 and still fall within the scope of the present technology. Various computing systems can perform the method 300, as described in connection with FIG. 5.

In step 305, users within the social network are profiled based on the data items they act upon or their interests. The interests can be derived from the automated semantic analysis of text in acted upon data items and mapping onto concepts included a general ontological database by a natural language processor. In step 310, a social graph is defined in which nodes represent the users within the social network and edges represent the explicit connections between the users. In step 315, a neighborhood graph is defined. Nodes can represent the users within the social network and edges can link each user to a predefined number of other users within the social network with highest similarity in tastes or interests. In step 320, a social affinity graph is defined by the union of the social graph and the neighborhood graph. In step 325, data items acted upon by users within the social network are identified in a given time interval. In step 330, users within the social network are determined that have acted upon the identified data items. In step 335, each node of the social affinity graph corresponding to such a user is injected with an initial numerical endorsement value for each item acted upon by the user. In step 340, endorsement values are propagated across the social affinity graph until some stopping criteria is met. In step 345, a sorted list of items acted upon by other users is generated for each user within the social network. The sorted list can be based on the final endorsement values accumulated for each identified item at the user's node.

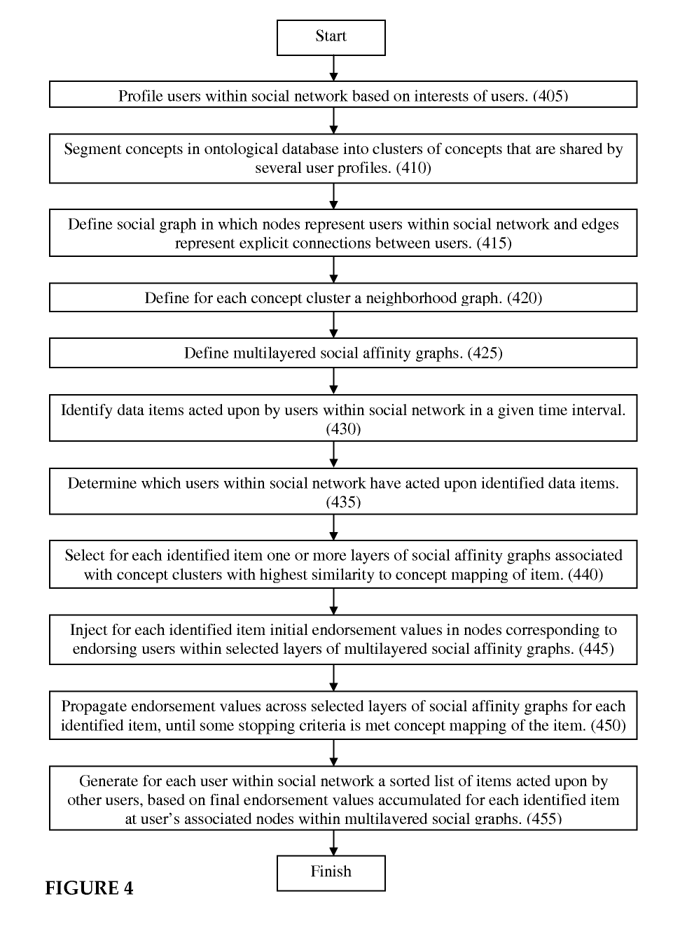

FIG. 4 is a flowchart illustrating an exemplary method 400 of generating with a computing system personalized sorted lists of data items for users within an online social network. The steps of the method 400 may be performed in varying orders. Additionally, steps may be added or subtracted from the method 400 and still fall within the scope of the present technology. Various computing systems can perform the method 400, as described in connection with FIG. 5.

In step 405, users within the social network are profiled based on their interests. The interests can be derived from the automated semantic analysis of text in acted upon data items and mapping onto concepts included in a general ontological database by a natural language processor. In step 410, concepts are segmented in the ontological database into clusters of concepts that are shared by several user profiles. In step 415, a social graph is defined in which nodes represent the users within the social network and edges represent the explicit connections between the users. In step 420, a neighborhood graph for each concept cluster is defined. The nodes can represent the users within the social network and edges can link each user to a predefined number of other users within the social network with highest similarity in interests within the concept cluster. In step 425, multilayered social affinity graphs are defined. Each layer can correspond to a different concept cluster, and may be formed by the union of the social graph and the neighborhood graph defined for the concept cluster. In step 425, data items acted upon by users within the social network in a given time interval are identified. In step 430, users within the social network that have acted upon the identified data items are determined. In step 435, one or more layers of the social affinity graphs are selected for each identified item. The one or more layers may be associated with the concept clusters with highest similarity to the concept mapping of the item. In step 440, initial endorsement values in the nodes are injecting for each identified item. The nodes may correspond to the endorsing users within the selected layers of the multilayered social affinity graphs. In step 445, the endorsement values are propagated across the selected layers of the social affinity graphs for each identified item until some stopping criteria is met. In step 450, a sorted list of items acted upon by other users is generated for each user within the social network. Each sorted list may be based on the final endorsement values accumulated for each identified item at the user's associated nodes within the multilayered social graphs.

FIG. 5 illustrates an exemplary computing system 500 that may be used to implement an embodiment of the present technology. The computing system 500 includes one or more processors 510 and main memory 520. Main memory 520 stores, in part, instructions and data for execution by processor 510. Main memory 520 can store the executable code when in operation. The computing system 500 further includes a mass storage device 530, portable storage medium drive(s) 540, output devices 550, user input devices 560, a graphics display 570, and peripheral device(s) 580.

The components shown in FIG. 5 are depicted as being connected via a single bus 590. The components may be connected through one or more data transport means. The processor 510 and the main memory 520 may be connected via a local microprocessor bus, and the mass storage device 530, the peripheral devices 580, the portable storage medium drive(s) 540, and display system 570 may be connected via one or more input/output (I/O) buses.

The mass storage device 530, which may be implemented with a magnetic disk drive or an optical disk drive, is a non-volatile storage device for storing data and instructions for use by the processor 510. The mass storage device 530 can store the system software for implementing embodiments of the present invention for purposes of loading that software into the main memory 520.

The portable storage device 540 operates in conjunction with a portable non-volatile storage medium, such as a floppy disk, compact disk, digital video disc, or USB storage device, to input and output data and code to and from the computer system 500 of FIG. 5. The system software for implementing embodiments of the present invention may be stored on such a portable medium and input to the computer system 500 via the portable storage device 540.

The input devices 560 provide a portion of a user interface. The input devices 560 may include an alpha-numeric keypad, such as a keyboard, for inputting alpha-numeric and other information, or a pointing device, such as a mouse, a trackball, stylus, or cursor direction keys. Additionally, the computing system 500 as shown in FIG. 5 includes the output devices 550. Suitable output devices include speakers, printers, network interfaces, and monitors.

The display system 570 may include a liquid crystal display (LCD) or other suitable display device. The display system 570 receives textual and graphical information, and processes the information for output to the display device.

The peripheral device(s) 580 may include any type of computer support device to add additional functionality to the computer system. The peripheral device(s) 580 may include a modem or a router.

The components contained in the computer system 500 of FIG. 5 are those typically found in computer systems that may be suitable for use with embodiments of the present invention and are intended to represent a broad category of such computer components that are well known in the art. Thus, the computer system 500 of FIG. 5 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, webOS, Android, iPhone OS and other suitable operating systems.

It is noteworthy that any hardware platform suitable for performing the processing described herein is suitable for use with the technology. Computer-readable storage media refer to any medium or media that participate in providing instructions to a central processing unit (CPU), a processor, a microcontroller, or the like. Such media can take forms including, but not limited to, non-volatile and volatile media such as optical or magnetic disks and dynamic memory, respectively. Common forms of computer-readable storage media include a floppy disk, a flexible disk, a hard disk, magnetic tape, any other magnetic storage medium, a CD-ROM disk, digital video disk (DVD), any other optical storage medium, RAM, PROM, EPROM, a FLASHEPROM, any other memory chip or cartridge.

Various forms of transmission media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

While various embodiments have been described above, it should be understood that they have been presented by way of example only, and not limitation. The descriptions are not intended to limit the scope of the technology to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the technology as defined by the appended claims and otherwise appreciated by one of ordinary skill in the art. The scope of the technology should, therefore, be determined not with reference to the above description, but instead should be determined with reference to the appended claims along with their full scope of equivalents.

1. A method of generating with a computing system personalized sorted lists of data items for users within an online social network, the method comprising:
defining a social graph comprising nodes and edges, wherein the nodes represent the users within the social network and users within additional social networks and the edges represent explicit connections between the users within the social network and within the additional social networks, the explicit connections including connections described on personal webpages having markup and connections described in contact lists of online communication systems;
identifying data items acted upon by users within the social network in a given time interval;
determining which of the users within the social network have acted upon the identified data items;
injecting in each node associated with such user an initial numerical endorsement value for each item acted upon by the user;
propagating the endorsement values across the social graph until some stopping criteria is met;
generating for each user within the social network a sorted list of items acted upon by other users, based on the final endorsement values accumulated for each identified item at the user's node; and
filtering the sorted list of items by immediate relevance to the monitored context of the associated user, wherein the sorted list of items is used to adjust information being presented to the associated user, the information being selected from the group consisting of search engine results, messages received from contacts, and new entries in feeds subscribed by the associated user.

2. The method of claim 1, wherein the data items comprise one or more items uniquely referenced by a Uniform Resource Identifier (URI) from an Internet source accessed by users within the social network, the Internet source selected from the group consisting of: 1) a content site, 2) a blog, 3) an RSS feed, 4) an e-commerce site, and 5) a social message aggregator.

3. The method of claim 2, wherein the initial endorsement value attributed to an item acted upon is defined according to the actual action performed to reflect a level of interest in the item expressed explicitly or implicitly by the action.

4. The method of claim 3, wherein propagating the endorsement values across the social graph comprises:
retaining an α portion of the initially injected endorsement value for an item at an endorsing node u and distributing the remaining (1−α)-portion uniformly among the nodes connecting to u;
repeating the operation for each node and for each identified item, adding to the retained portion of the endorsement value at the node the amounts that reach it by propagation; and
stopping the operation for each node and for each identified item when either the portion of accumulated endorsement value to be redistributed down the in-links of the node falls below a threshold or the node has no in-links.

5. The method of claim 4, wherein a predetermined number of items with highest final endorsement values in the sorted list at a given node is presented as recommendation to the user associated with the node.

6. The method of claim 1, wherein acting upon a data item comprises one of publishing, reading, viewing the item, listening to the item following a hyperlink featured by the item, commenting on the item and submitting a numerical rating for the item.

7. The method of claim 1, wherein the initial endorsement value attributed to an item acted upon by a user is weighted by a factor representing the user's social authority derived from link-based analysis of the social graph structure.

8.-13. (canceled)

14. A method of generating with a computing system personalized sorted lists of data items for users within an online social network, the method comprising:
profiling users within the social network based on the data items they act upon or their interests, wherein the interests are derived from the automated semantic analysis of text in acted upon data items and mapping onto concepts included a general ontological database by a natural language processor;
defining a social graph comprising nodes and edges, wherein the nodes represent the users within the social network and users within additional social networks and the edges represent explicit connections between the users within the social network and within the additional social networks, the explicit connections including public connections described on personal webpages having markup;
defining a neighborhood graph, wherein nodes represent the users within the social network and edges link each user to a predefined number of other users within the social network with highest similarity in tastes or interests;
defining a social affinity graph by the union of the social graph and the neighborhood graph;
identifying data items acted upon by users within the social network in a given time interval;
determining which of the users within the social network have acted upon the identified data items;
injecting in each node of the social affinity graph corresponding to such a user an initial numerical endorsement value for each item acted upon by the user;
propagating the endorsement values across the social affinity graph until some stopping criteria is met;
generating for each user within the social network a sorted list of items acted upon by other users, based on the final endorsement values accumulated for each identified item at the user's node, and
filtering the sorted list of items by immediate relevance to the monitored context of the associated user, wherein the sorted list of items is used to adjust information being presented to the associated user, the information being selected from the group consisting of search engine results, messages received from contacts, and new entries in feeds subscribed by the associated user.

15. The method of claim 14, wherein the data items comprise one or more items uniquely referenced through a Uniform Resource Identifier (URI) from an Internet source accessed by users within the social network, the Internet source selected from the group consisting of: 1) a content site, 2) a blog, 3) an RSS feed, 4) an e-commerce site, and 5) a social message aggregator.

16. The method of claim 15, wherein the initial endorsement value attributed to an item acted upon is defined according to the actual action performed to reflect a level of interest in the item expressed explicitly or implicitly by the action.

17. The method of claim 16, wherein the similarity in tastes or interests between two users is measured by correlating their respective user profiles.

18. The method of claim 17, wherein propagating the endorsement values across the social affinity graph comprises:
retaining an α portion of the initially injected endorsement value for an item at an endorsing node u and distributing the remaining (1−α)-portion uniformly among the nodes connecting to u;
repeating the operation for each node and for each identified item, adding to the retained portion of the endorsement value at the node the amounts that reach it by propagation; and
stopping the operation for each node and for each identified item when either the portion of accumulated endorsement value to be redistributed down the in-links of the node falls below a threshold or the node has no in-links.

19. The method of claim 18, wherein a predetermined number of items with highest final endorsement values in the sorted list at a given node is presented as recommendation to the user associated with the node.

20. The method of claim 14, wherein acting upon a data item comprises one of publishing, reading, viewing the item, listening to the item, following a hyperlink featured by the item, commenting on the item and submitting a numerical rating for the item.

21. The method of claim 14, wherein the initial endorsement value attributed to an item acted upon by a user is weighted by a factor representing the user's social authority derived from link-based analysis of the social graph structure.

22.-24. (canceled)

25. The method of claim 14, wherein edges of the social affinity graph are weighted by at least one of the following factors: 1) profile similarity between users connected by an edge; or 2) degree of separation in the social graph.

26. The method of claim 25, wherein the (1−α)-portion of the endorsement value at any given node propagated across its in-links is distributed proportionally to their weights;

27.-29. (canceled)

30. A method of generating with a computing system personalized sorted lists of data items for users within an online social network, the method comprising:
profiling users within the social network based on their interests, wherein the interests are derived from the automated semantic analysis of text in acted upon data items and mapping onto concepts included in a general ontological database by a natural language processor;
segmenting the concepts in the ontological database into clusters of concepts that are shared by several user profiles;
defining a social graph comprising nodes and edges, wherein the nodes represent the users within the social network and users within additional social networks and the edges represent explicit connections between the users within the social network and within the additional social networks, the explicit connections including connections described on personal webpages having markup and connections described in contact lists of online communication systems;
defining for each concept cluster a neighborhood graph, wherein nodes represent the users within the social network and edges link each user to a predefined number of other users within the social network with highest similarity in interests within the concept cluster;
defining multilayered social affinity graphs, wherein each layer corresponds to a different concept cluster and is formed by the union of the social graph and the neighborhood graph defined for the concept cluster;
identifying data items acted upon by users within the social network in a given time interval;
determining which of the users within the social network have acted upon the identified data items;
selecting for each identified item one or more layers of the social affinity graphs associated with the concept clusters with highest similarity to the concept mapping of the item;
injecting for each identified item initial endorsement values in the nodes corresponding to the endorsing users within the selected layers of the multilayered social affinity graphs;
propagating the endorsement values across the selected layers of the social affinity graphs for each identified item, until some stopping criteria is met;
generating for each user within the social network a sorted list of items acted upon by other users, based on the final endorsement values accumulated for each identified item at the user's associated nodes within the multilayered social graphs; and
filtering the sorted list of items by immediate relevance to the monitored context of the associated user, wherein the sorted list of items is used to adjust information being presented to the associated user, the information being selected from the group consisting of search engine results, messages received from contacts, and new entries in feeds subscribed by the associated user.

31. The method of claim 30, wherein the data items comprise one or more items uniquely referenced by a Uniform Resource Identifier (URI) from an Internet source accessed by users within the social network, the Internet source selected from the group consisting of: 1) a content site, 2) a blog, 3) an RSS feed, 4) an e-commerce site, and 5) a social message aggregator.

32. The method of claim 31, wherein the initial endorsement value attributed to an item acted upon is defined according to the actual action performed to reflect a level of interest in the item expressed explicitly or implicitly by the action.

33. The method of claim 32, wherein the similarity in interests between two users for a given concept cluster is measured by correlating the respective components of their user profiles pertaining to the concept cluster;

34. The method of claim 33, wherein the similarity between a concept cluster and a data item is measured by the projection of the concept mapping of the item onto the concept cluster.

35. The method of claim 34, wherein the steps of propagating the endorsement values across a layer of the social affinity graphs comprises:
retaining an α portion of the initially injected endorsement value for an item at an endorsing node u and distributing the remaining (1−α)-portion uniformly among the nodes connecting to u within the layer;
repeating the operation for each node and for each identified item, adding to the retained portion of the endorsement value at the node the amounts that reach it by propagation; and
stopping the operation for each node and for each identified item when either the portion of accumulated endorsement value to be redistributed down the in-links of the node falls below a threshold or the node has no in-links.

36. The method of claim 35, wherein a predetermined number of items with highest final endorsement values in the sorted list at a given node is presented as recommendation to the user associated with the node.

37. The method of claim 30, wherein acting upon a data item comprises one of publishing, reading, viewing or listening to the item as the case may be, following through a hyperlink featured by the item, commenting on the item and submitting a numerical rating for the item.

38. The method of claim 30, wherein the initial endorsement value attributed to an item acted upon by a user is weighted by a factor representing the user's social authority derived from link-based analysis of the social graph structure.

39.-41. (canceled)

42. The method of claim 30, wherein edges of the multilayered social affinity graphs are weighted by at least one of the following factors: 1) concept cluster-specific profile similarity between users connected by an edge; or 2) degree of separation in the social graph.

43. The method of claim 42, wherein the (1−α)-portion of the endorsement value at any given node propagated across its in-links within a given layer of the social affinity graphs is distributed proportionally to their weights;

44.-46. (canceled)
